(19) United States
(12) Patent Application Publication
(10) Pub. No.: US 2011/0265132 A1
(43) Pub. Date: Oct. 27, 2011

(54) Live TV Broadcast Method of Digital Interactive TV

(75) Inventors: Bin Wang, Guangzhou (CN); Yixue Zhuang, Guangzhou (CN); Liheng Xu, Guangzhou (CN); Jianhua Li, Guangzhou (CN); Qiaofeng Ling, Guangzhou (CN); Tao Yang, Guangzhou (CN)

(73) Assignee: GUANGZHOU DIGITAL MEDIA GROUP CO., LTD., Guangzhou (CN)

(21) Appl. No.: 13/070,048

(22) Filed: Mar. 23, 2011

(30) Foreign Application Priority Data
Apr. 22, 2010 (CN) 201010159061.4

(51) Int. Cl. H04N 7/173

(52) U.S. Cl. 725/93

(57) ABSTRACT

A live TV broadcast method of digital interactive TV, which enables the whole network to share one set of CMTS for independent live broadcast: CMTS of each hub head-end is used for on-demand broadcast; Cable Modem aims to receive directives from users to seek downlink frequency corresponding to the IP address according to frequency IP list stored with IP addresses and downlink frequencies for advanced multicast. After that, data flow shall be sent to users through bridging by Cable Modem. As Cable Modem can directly perform the switchover, there is no need to use CMTS to receive uplink data. This is favorable for significant reduction of afflux of various interferences signals and off-line of Cable Mode, which can ensure normal and stable broadcast of programs in case of off-line.

### FIELD OF THE INVENTION

The invention relates to the field of digital interactive TV, particularly to a live TV broadcast method of digital interactive TV.

### BACKGROUND OF THE INVENTION

With development of technologies and increasing demands of people for individualized TV programs, on-demand programs have won high favors from audiences owing to their high interactivity.

Normally, topological structure of digital interactive TV is as shown in FIG. 1. Hub head-end in the network applies one set of CMTS(Cable Modem Terminal System) for live broadcast and on-demand broadcast. Once TV directives from users are received by the Cable Modem, a request shall be sent from the uplink of CMTS to CMTS. After that, live broadcast or on-demand broadcast data shall be downloaded by the CMTS according to request for demodulation inside the Cable Modem before further transmission to users according to target address of such directives. Such system solution can effectively satisfy the requirements for live broadcast and on-demand broadcast of digital TV.

However, uplink of CMTS shall be shared by a mass of users once Cable Modem is accessed to the network, which shall be in a complicated environment of electromagnetic wave as affected by such factors as interferences from household appliances, industrial equipments and lightning. As a result of it, the whole cable network shall be like an enormous grid antenna, in which various interferences shall flow in through such channels as user port/cable. This will seriously affect the normal transmission of data signals from uplink channel. Furthermore, with increase in the number of users, congestion to the on-demand broadcast would incur off-line of users' Cable Modem to the extent of resulting in suspension of all TV programs. For TV broadcast industry, suspension of live broadcasted programs is a problem that must be settled.

### SUMMARY OF THE INVENTION

The object of the present invention is to provide a live TV broadcast method of digital interactive TV for further provision of stable live broadcasted programs.

A live TV broadcast method of digital interactive TV, with which, CMTS of each huh head-end is used for on-demand broadcast; Cable Modem aims to receive directives from users to seek downlink frequency corresponding to the IP address according to frequency IP list stored with IP addresses and downlink frequencies that locked in advance; data flow shall be sent to users by Cable Modem through bridging.

According to aforesaid live broadcast method of digital interactive TV of the invention, the whole network makes use of one set of CMTS for independent transmission of data flow; CMTS of each hub head-end is used for on-demand broadcast; in case of switchover of TV programs as requested by users, the Cable Modem shall send data flow to users through bridging; according to this method, as Cable Modem can directly perform the switchover, there is no need to use CMTS to receive uplink data; this is favorable for significant reduction of afflux of various interference signals and off-line of Cable Modem; furthermore, as CMTS for both live broadcast and on-demand broadcast is connected to different tuners inside the Cable Modem, such tuners inside the Cable Modem as accessed to live broadcast data can still realize the normal live broadcast of programs. This aims to ensure the stability of live broadcasted programs according to IP list stored in advance even in case of congestion to on-demand data from CMTS of hub head-end and off-line of connected tuners; moreover, as the whole network requires only one set of CMTS for live broadcast through the server, which is favorable for reduction of total CMTS quantity and saving of costs as compared with prior art, in which, CMTS of each hub head-end is responsible for both live broadcast and on-demand broadcast.

### BRIEF DESCRIPTION OF THE DRAWINGS

FIG. 1 is a diagram for existing topological structure of digital interactive TV system of the invention;

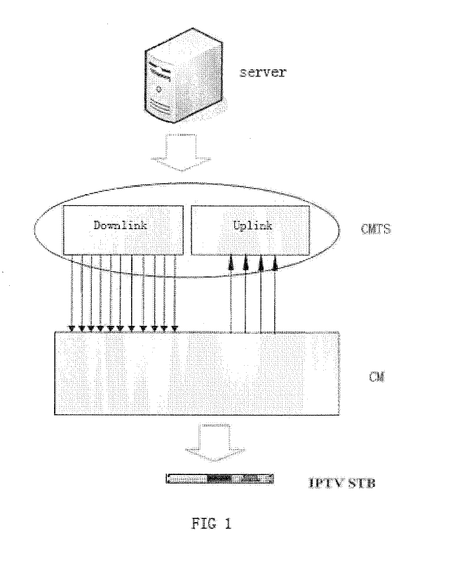

FIG. 2 is a diagram for topological structure of digital interactive TV system of the invention;

FIG. 3 is a diagram for network structure of digital interactive TV system of the invention;

FIG. 4 is a diagram for distribution of frequency points of live broadcasted programs.

### DETAILED DESCRIPTION OF THE PREFERRED EMBODIMENT

The invention is further explained in accordance with attached drawings as follows:

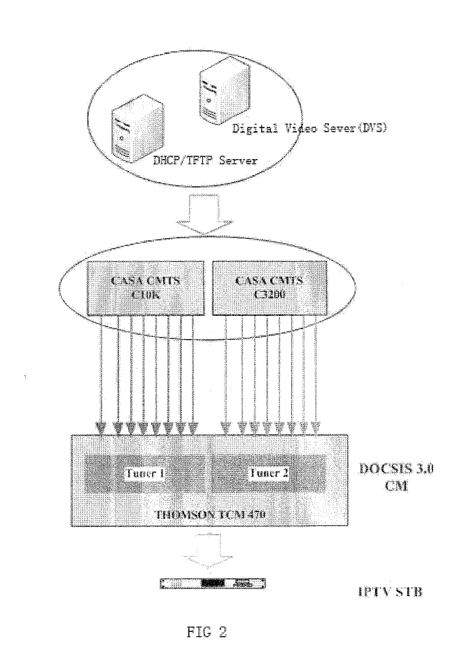

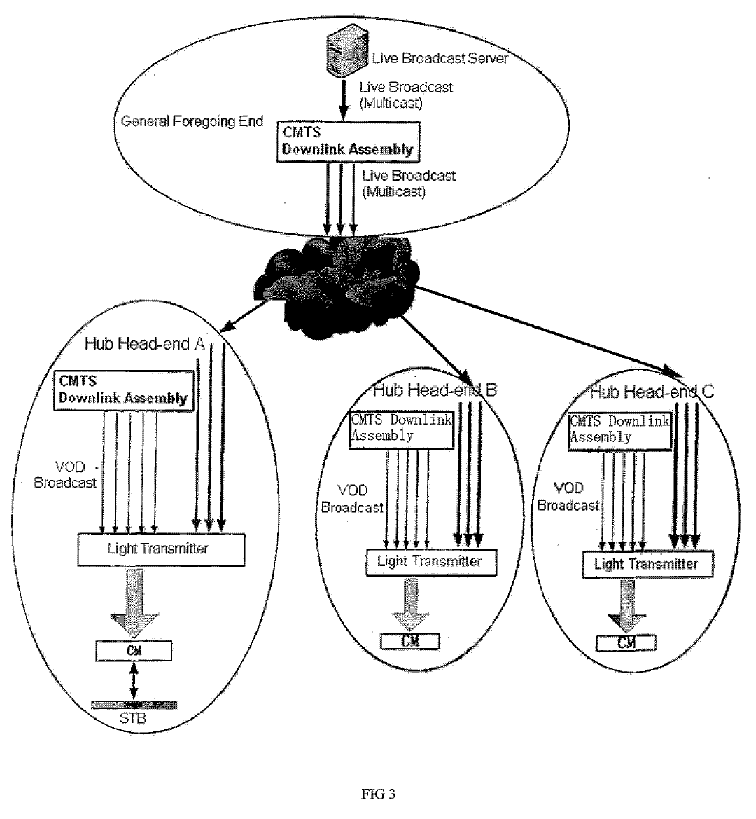

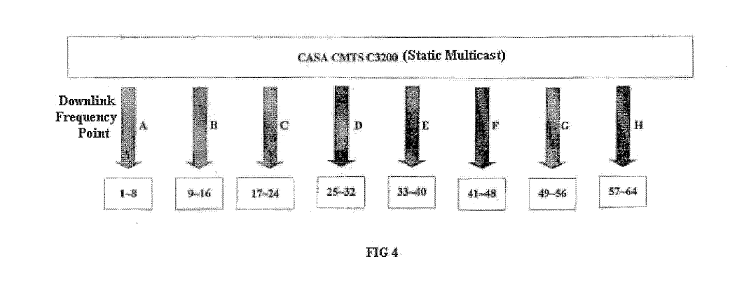

As shown in FIG. 2 and FIG. 3, the whole network makes use of one set of CMTS (Model: CASA C3200) for independent live broadcast, in which, 64 programs are provided for users through static multicast function; such static multicast function is available for continuous transmission of multicast flow on some fixed downlink frequency points no matter users have applied for multicast or not; furthermore, such 64 programs can be distributed on the 8 downlink frequency points as shown in FIG. 4; CMTS of each hub head-end, namely CMTS accessed to client machine room, can serve as the CMTS of machine rooms at county, district and town levels for on-demand broadcast, of which, the model is CASACLOK; Cable Modem is in accordance with DOCSIS 3.0 (Data Over Cable Service Interface Specification 3.0), of which, standard model is THOMSON TCM 470; such Cable Modem is equipped with two tuners; Tuner 1 is used for receiving video on-demand broadcast; Whereas tuner 2 is used for receiving live broadcast. Tuner 1 of THOMSON TCM 470 is registered on the CASA CMTS CLOK, which makes use of Cable Modem to download frequency IP list from the server; such list includes IP address and downlink frequency for multicast; Cable Modem shall automatically search downlink frequency corresponding to the IP address for multicast once directives from client STB are received by it; such downlink frequency shall be locked by Tuner 2 for transmission to users by Cable Modem through bridging. As such operation is automatically executed by Cable Modem, there is no need to use CMTS to perform switchover of Cable Modem. Therefore, once on-demand broadcast is suspended due to off-line of Tuner 1 of Cable Modem, Cable Modem will still be able to send static multicast flow to client STB through Tuner 2 to ensure normal live broadcast.

In the original system, a frequency band is separated from each set of CMTS for live broadcast with another one being separated for on-demand broadcast; according to proposal of this invention, all live broadcasted programs are assumed by CMTS of one server; for the whole network, it is favorable for minimization of CMTS and reduction of costs.

Three embodiments for switchover of programs with this method are stated as follows:

### Embodiment 1

Embodiment 1: In the event that any user makes a switchover from live broadcast channel 1 to 9 when Cable Modem is at any status, Cable Modem shall search frequency IP list to facilitate switchover from frequency point A to B through Tuner 2;

Work flow for switchover of live broadcast programs is as follows:
1. Any user can make a switchover from channel 1 to 9 with remote controller when TV is on channel 1, and Cable Modem is at frequency point A;
2. Directives for switchover arc sent from STB to Cable Modem;
3. As discovered by Cable Modem through searching frequency IP list upon receipt of directives, channel 9 is at frequency point B;
4. Cable Modern makes a switchover from frequency point A to B through Tuner 2;
5. Cable Modem receives multicast flow data from channel 9 at frequency point B of Tuner 2 for transmission to STB through bridging;

### Embodiment 2

Embodiment 2: Cable Modem must be online to facilitate switchover from channel 1 to on-demand broadcast by users; under such circumstance, Cable Modem shall be requested to make a switchover from Tuner 2 to Tuner 1;

Work flow for switchover of live broadcast programs is as follows:
1. Any user can make a switchover from channel 1 to on-demand broadcast with remote controller when the TV is on channel 1, and Cable Modem is at frequency point A of Tuner 2;
2. Directives for switchover are sent from STB to Cable Modem;
3. Cable Modem makes a switchover from Tuner 2 to Tuner 1 upon receipt of directives;
4. Cable Modem makes a switchover from frequency point A of Tuner 2 to frequency point of Tuner 1;
5. Cable Modem receives on-demand data at frequency point of Tuner 1 for transmission to STB.

### Embodiment 3

Embodiment 3: Any user can make a switchover from on-demand broadcast to live broadcast channel 9 if on-demand programs are not available due to offline of Cable Modem; under such circumstance, Cable Modem shall search frequency IP list for switchover from Tuner 1 to frequency point B of Tuner 2.

Work flow for switchover live broadcast programs is stated as follows:
1. Any user can make a switchover from VOD channel to channel 9 with remote controller when the TV is on on-demand VOD, and Cable Modem is offline at Tuner 1;
2. Directives are sent from STB to Cable Modem;
3. As discovered by Cable Modem through searching frequency IP list upon receipt of directives for switchover, channel 9 is at the frequency point B of Tuner 2.
4. Cable Modem makes a switchover from Tuner 1 to Tuner 2 and frequency point B simultaneously;
5. Cable Modem receives multicast floe data from channel 9 at frequency point B of Tuner 2 for transmission to STB through bridging.

What is claimed is:

1. A live TV broadcast method of digital interactive TV, which is characterized in that the server terminal of the whole network shares one set of CMTS for independent live broadcast; CMTS of each hub head-end is used for on-demand broadcast; cable modem aims to receive directives from users to seek downlink frequency corresponding to the IP address according to frequency IP list stored with IP addresses and downlink frequencies for advanced; data flow shall be sent to users by Cable Modem through bridging.

2. A live TV broadcast method of digital interactive TV according to claim 1, which is characterized in that aforesaid frequency IP list is downloaded and updated from server through Cable Modem.

3. A live TV broadcast method of digital interactive TV according to claim 1, which is characterized in that 2 or more tuners are provided inside the Cable Modem, which are connected to CMTS for transmission of different data.
